(19) United States
(12) Patent Application Publication
(10) Pub. No.: US 2014/0283102 A1
(43) Pub. Date: Sep. 18, 2014

(54) METHOD FOR RECEIVING ENTERED DATA AND INFORMATION PROCESSING DEVICE

(71) Applicant: FUJITSU LIMITED, Kawasaki-shi (JP)

(72) Inventor: Takayuki KIRIGAYA, Saitama (JP)

(73) Assignee: FUJITSU LIMITED, Kawasaki-shi (JP)

(21) Appl. No.: 14/099,057

(22) Filed: Dec. 6, 2013

(30) Foreign Application Priority Data
Mar. 18, 2013 (JP) 2013-054640

(51) Int. Cl. G06F 21/45

(52) U.S. Cl. CPC G06F 21/45
USPC 726/26

(57) ABSTRACT

A computer displays a first screen for left eye and a second screen for right eye in a same display region of a display device. The computer acquires an event corresponding to an operation performed on a screen displayed in the display region. The computer identifies a screen used as a standard screen from among the first screen and the second screen. The computer identifies an instruction provided by the event on basis of the screen used as the standard screen.

### CROSS-REFERENCE TO RELATED APPLICATION

This application is based upon and claims the benefit of priority of the prior Japanese Patent Application No. 2013-054640, filed on Mar. 18, 2013, the entire contents of which are incorporated herein by reference.

### FIELD

The embodiments discussed herein are related to a method for receiving entered data and an information processing device.

### BACKGROUND

For an entry of information using a touch panel, a technique for systems that protect entered information has been proposed to inhibit or suppress the use of information inappropriately obtained by peering at the touch panel.

According to the technique, a multi-view touch panel that displays different images in different directions is used to display a password entry screen for a user in a front direction and another password entry screen in another direction, while key arrangements of the password entry screens are different from each other. When the user enters an appropriate password, a character string that is read from the other password entry screen is recorded as a decoy password. When a third person who peers at the panel in the other direction and enters the decoy password for impersonation, the entry of the decoy password is detected.

The technique detects the fact that the third person has peered at the panel in a direction different from the direction of the line of sight of the user and entered the password for the impersonation. The technique, however, does not inhibit the appropriate password from being stolen and used when the third person peers at the panel in the same direction as the user.

Related technique is disclosed in, for example, Japanese Laid-open Patent Publication No. 2008-33747.

### SUMMARY

According to an aspect of the present invention, provided is a method for receiving entered data. In the method, a computer displays a first screen for left eye and a second screen for right eye in a same display region of a display device. The computer acquires an event corresponding to an operation performed on a screen displayed in the display region. The computer identifies a screen used as a standard screen from among the first screen and the second screen. The computer identifies an instruction provided by the event on basis of the screen used as the standard screen.

The objects and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a common layout of security code entry screens;

FIG. 2 is a diagram illustrating an example of a security code entry screen for left eye;

FIG. 3 is a diagram illustrating an example of a security code entry screen for right eye;

FIG. 4 is a diagram illustrating an example of an operation of entering a security code;

FIG. 5 is a diagram illustrating an example of a hardware configuration of a mobile phone terminal;

FIG. 6 is a diagram illustrating an example of a functional configuration of a mobile phone terminal;

FIG. 7 is a diagram illustrating an example of an assignment table for left eye;

FIG. 8 is a diagram illustrating an example of an assignment table for right eye;

FIG. 9 is a flowchart of an overall process;

FIG. 10 is a flowchart of a process (A) of identifying a screen;

FIG. 11 is a diagram illustrating an example of a screen specifying table;

FIG. 12 is a flowchart of a process (B) of identifying a screen;

FIG. 13 is a diagram illustrating an example of a functional configuration of a mobile phone terminal according to a third embodiment;

FIG. 14 is a flowchart of an overall process according to a third embodiment;

FIG. 15 is a flowchart of a process (C) of identifying a screen;

FIG. 16 is a flowchart of a process (D) of identifying a screen; and

FIG. 17 is a flowchart of an overall process according to a sixth embodiment.

### DESCRIPTION OF EMBODIMENTS

### First Embodiment

In the first embodiment, a display device that displays an image for left eye and an image for right eye is used. For example, a three-dimensional (3D) display device is used. Hereinafter, a naked-eye stereoscopic display device that uses a parallax barrier is described as an example. The naked-eye stereoscopic display device emits light for displaying an image for left eye toward the left eye of an operator and emits light for displaying an image for right eye toward the right eye of the operator.

In the first embodiment, a parallax display device is used to display security code entry screens. In this case, the security code entry image for left eye and the security code entry image for right eye have a common layout, except for parts of the images.

FIG. 1 illustrates an example of the common layout of the security code entry screens. FIG. 1 illustrates common elements of the security code entry image for left eye and security code entry image for right eye. Ranges 101a to 101l are each a range in which a button for receiving an entry performed by a touch operation of the operator is displayed. In this example, the ranges 101a to 101l are arranged in a matrix of three rows and four columns.

The range 101a is arranged in the first row and the first column. The range 101b is arranged in the second row and the first column. The range 101c is arranged in the third row and the first column. The range 101d is arranged in the first row and the second column. The range 101e is arranged in the second row and the second column. The range 101f is arranged in the third row and the second column. The range 101g is arranged in the first row and the third column. The range 101h is arranged in the second row and the third column. The range 101i is arranged in the third row and the third column. The range 101j is arranged in the first row and the fourth column. The range 101k is arranged in the second row and the fourth column. The range 101l is arranged in the third row and the fourth column.

A code display region 103 is a region for displaying a received code. In this example, the reception of a code is indicated by displaying a symbol (for example, “*”) in the code display region 103 in place of an entered character in order to conceal the entered character.

Numeric buttons are assigned to ranges 101, respectively, while the ranges 101 are among the ranges 101a to 101l. When a range 101 to which a numeric button is assigned is touched, an entry of a number indicated by the numeric button is received. An execution button for receiving an instruction for execution is assigned to a range that is among the ranges 101a to 101l and is not any of the ranges 101 to which the numeric buttons are assigned. A cancellation button for receiving an instruction for cancellation is assigned to another range that is among the ranges 101a to 101l and is not any of the ranges 101 to which the numeric buttons are assigned. The security code entry screen for left eye and the security code entry screen for right eye are displayed while being synchronized with each other.

FIG. 2 illustrates the security code entry screen for left eye. Buttons 201a to 201j are each a button icon for receiving an entry of a number. The buttons 201a to 201j are displayed in the ranges 101a to 101j illustrated in FIG. 1, respectively. A button 201k is an execution button for receiving an instruction for execution and is displayed in the range 101k illustrated in FIG. 1. A button 201l is a cancellation button for receiving an instruction for cancellation and is displayed in the range 101l illustrated in FIG. 1.

FIG. 3 illustrates the security code entry screen for right eye. Buttons 301a to 301j are each a button icon for receiving an entry of a number. The buttons 301a to 301j are displayed in the ranges 101a to 101j illustrated in FIG. 1, respectively. A button 301k is a cancellation button for receiving an instruction for cancellation and is displayed in the range 101k illustrated in FIG. 1. A button 301l is an execution button for receiving an instruction for execution and is displayed in the range 101l illustrated in FIG. 1.

The arrangement of numbers on the button icons displayed in the security code entry screen (illustrated in FIG. 2) for left eye is different from the arrangement of numbers on the button icons displayed in the security code entry screen (illustrated in FIG. 3) for right eye. The execution button 201k and the cancellation button 201l displayed in the security code entry screen (illustrated in FIG. 2) for left eye are opposite in position to the cancellation button 301k and the execution button 301l displayed on the security code entry screen (illustrated in FIG. 3) for right eye.

An example in which an operation of entering a security code is performed in the state in which the security code entry screens illustrated in FIGS. 2 and 3 are displayed is described below. FIG. 4 illustrates an example of the operation of entering a security code. Touched positions 401, 403, 405, and 407 are positions at which numeric buttons are touched in the order of the positions 401, 403, 405, and 407. The touched position 401 is the position at which the button is touched first. The touched position 403 is the position at which the button is touched second. The touched position 405 is the position at which the button is touched third. The touched position 407 is the position at which the button is touched fourth.

If the operator operates the display device while seeing the security code entry screen for left eye, the operator tries to enter numbers “1”, “7”, “8”, and “3”. Thus, if the security code entry screen (illustrated in FIG. 2) for left eye is a standard screen, the display device receives the numbers “1”, “7”, “8”, and “3” in the order of the numbers “1”, “7”, “8”, and “3”.

If the operator operates the display device while seeing the security code entry screen for right eye, the operator tries to enter numbers “2”, “0”, “3”, and “8”. Thus, if the security code entry screen (illustrated in FIG. 3) for right eye is the standard screen, the display device receives the numbers “2”, “0”, “3”, and “8” in the order of the numbers “2”, “0”, “3”, and “8”.

Specifically, the display device switches between received codes on the basis of whether the security code entry screen for left eye or the security code entry screen for right eye is the standard screen.

Next, a hardware configuration of a mobile phone terminal is described. FIG. 5 illustrates an example of the hardware configuration of a mobile phone terminal. A mobile phone terminal 500 includes a processor 501, a storage unit 503, an antenna 511, a radio controller 513, an audio controller 515, a speaker 517, a microphone 519, a display 521, a touch pad 523, a key group 525, a liquid crystal shutter controller 527, and a camera 529.

The processor 501 may include a modem central processing unit (CPU) and an application CPU. The storage unit 503 includes a read-only memory (ROM) 505, a random access memory (RAM) 507, and a flash memory 509, for example. The ROM 505 stores therein a program such as an application program and set data, for example. The RAM 507 includes a region into which the program such as the application program is loaded, for example. The RAM 507 includes a region for storing temporary data. The flash memory 509 stores set data and data to be held, for example.

The touch pad 523 is a panel-shaped sensor arranged on a display screen of the display 521 and receives an instruction provided by an operation of touching the touch pad 523. The display 521 displays various screens generated by the execution of the application program. Specifically, the display 521 and the touch pad 523 are used as a unified touch panel. A touch event is generated by an operation of touching the touch pad 523. The touch pad 523 is an example of a pointing device (position indicator). Hardware keys of the key group 525 are arranged at a part of a casing of the mobile phone terminal 500.

The display 521 is an example of the display device that displays the image for left eye and the image for right eye. For example, as the display 521, a naked-eye stereoscopic display device that uses a parallax barrier or a frame sequential 3D display device is used.

The touch pad 523 may be a resistive touch pad, a capacitive touch pad, an optical touch pad, or an electromagnetic touch pad. The touch pad 523 may be a device other than touch pads as long as the device has similar pointing performance to the touch pad 523. An arbitrary pointing device such as a mouse, a trackball, or object tracking by real-time analysis of a camera image may be used instead of the touch pad 523.

The antenna 511 receives radio data through a cellular communication system, a wireless local area network (LAN), near field communication, or the like. The radio controller 513 controls radio communication. By the control of the radio communication, audio communication is executed through phones and data communication is executed through emails.

The audio controller 515 executes analog-to-digital conversion and digital-to-analog conversion on audio data. The speaker 517 outputs analog data as a sound. The microphone 519 converts a sound into analog data.

The camera 529 is located so as to take an image of the face of the operator. If the frame sequential 3D display device is used, liquid crystal shutter glasses 551 are connected to the liquid crystal shutter controller 527. The liquid crystal shutter controller 527 controls light shielding of liquid crystal shutters included in the liquid crystal shutter glasses 551 and provided for respective eyes.

FIG. 6 illustrates an example of a functional configuration of the mobile phone terminal 500. The mobile phone terminal 500 includes a first storage unit 601, a display unit 603, an acquirer 605, a screen identifying unit 607, a code identifying unit 609, a second storage unit 611, a controller 613, a determining unit 615, and an output unit 617. The first storage unit 601 stores data of the security code entry screen (illustrated in FIG. 2) for left eye, data of the security code entry screen (illustrated in FIG. 3) for right eye, assignment tables for buttons and codes, and set data including the password and the standard screen. A part of the ROM 505 and the flash memory 509 is used for the first storage unit 601.

The assignment tables are described below. FIG. 7 illustrates an assignment table for left eye. The assignment table for left eye has a record for each button. In each record, a button identifier (ID) is assigned with a code or an instruction. The assignment table (illustrated in FIG. 7) for left eye corresponds to the security code entry screen (illustrated in FIG. 2) for left eye.

A button ID “LA” is an ID that identifies a button displayed in the range 101a (illustrated in FIG. 1) on the security code entry screen (illustrated in FIG. 2) for left eye. The button ID “LA” is assigned with a code “1”. A button ID “LB” is an ID that identifies a button displayed in the range 101b (illustrated in FIG. 1) on the security code entry screen (illustrated in FIG. 2) for left eye. The button ID “LB” is assigned with a code “4”. A button ID “LC” is an ID that identifies a button displayed in the range 101c (illustrated in FIG. 1) on the security code entry screen (illustrated in FIG. 2) for left eye. The button ID “LC” is assigned with a code “7”. A button ID “LD” is an ID that identifies a button displayed in the range 101d (illustrated in FIG. 1) on the security code entry screen (illustrated in FIG. 2) for left eye. The button ID “LD” is assigned with a code “2”. A button ID “LE” is an ID that identifies a button displayed in the range 101e (illustrated in FIG. 1) on the security code entry screen (illustrated in FIG. 2) for left eye. The button ID “LE” is assigned with a code “5”. A button ID “LF” is an ID that identifies a button displayed in the range 101f (illustrated in FIG. 1) on the security code entry screen (illustrated in FIG. 2) for left eye. The button ID “LF” is assigned with a code “8”. A button ID “LG” is an ID that identifies a button displayed in the range 101g (illustrated in FIG. 1) on the security code entry screen (illustrated in FIG. 2) for left eye. The button ID “LG” is assigned with a code “3”. A button ID “LH” is an ID that identifies a button displayed in the range 101h (illustrated in FIG. 1) on the security code entry screen (illustrated in FIG. 2) for left eye. The button ID “LH” is assigned with a code “6”. A button ID “LI” is an ID that identifies a button displayed in the range 101i (illustrated in FIG. 1) on the security code entry screen (illustrated in FIG. 2) for left eye. The button ID “LI” is assigned with a code “9”. A button ID “U” is an ID that identifies a button displayed in the range 101j (illustrated in FIG. 1) on the security code entry screen (illustrated in FIG. 2) for left eye. The button ID “U” is assigned with a code “0”. The data entered by a number entry is identified on the basis of the codes.

A button ID “LK” is an ID that identifies a button displayed in the range 101k (illustrated in FIG. 1) on the security code entry screen (illustrated in FIG. 2) for left eye. The button ID “LK” is assigned with “execution” of an instruction. A button ID “LL” is an ID that identifies a button displayed in the range 101l (illustrated in FIG. 1) on the security code entry screen (illustrated in FIG. 2) for left eye. The button ID “LL” is assigned with “cancellation” of an instruction.

FIG. 8 illustrates an assignment table for right eye. The assignment table for right eye has a record for each button in the same manner as the table illustrated in FIG. 7. In each record, a button ID is assigned with a code or an instruction. The assignment table (illustrated in FIG. 8) for right eye corresponds to the security code entry screen (illustrated in FIG. 3) for right eye.

A button ID “RA” is an ID that identifies a button displayed in the range 101a (illustrated in FIG. 1) on the security code entry screen (illustrated in FIG. 3) for right eye. The button ID “RA” is assigned with the code “2”. A button ID “RB” is an ID that identifies a button displayed in the range 101b (illustrated in FIG. 1) on the security code entry screen (illustrated in FIG. 3) for right eye. The button ID “RB” is assigned with the code “1”. A button ID “RC” is an ID that identifies a button displayed in the range 101c (illustrated in FIG. 1) on the security code entry screen (illustrated in FIG. 3) for right eye. The button ID “RC” is assigned with the code “0”. A button ID “RD” is an ID that identifies a button displayed in the range 101d (illustrated in FIG. 1) on the security code entry screen (illustrated in FIG. 3) for right eye. The button ID “RD” is assigned with the code “5”. A button ID “RE” is an ID that identifies a button displayed in the range 101e (illustrated in FIG. 1) on the security code entry screen (illustrated in FIG. 3) for right eye. The button ID “RE” is assigned with the code “4”. A button ID “RF” is an ID that identifies a button displayed in the range 101f (illustrated in FIG. 1) on the security code entry screen (illustrated in FIG. 3) for right eye. The button ID “RF” is assigned with the code “3”. A button ID “RG” is an ID that identifies a button displayed in the range 101g (illustrated in FIG. 1) on the security code entry screen (illustrated in FIG. 3) for right eye. The button ID “RG” is assigned with the code “8”. A button ID “RH” is an ID that identifies a button displayed in the range 101h (illustrated in FIG. 1) on the security code entry screen (illustrated in FIG. 3) for right eye. The button ID “RH” is assigned with the code “7”. A button ID “RI” is an ID that identifies a button displayed in the range 101i (illustrated in FIG. 1) on the security code entry screen (illustrated in FIG. 3) for right eye. The button ID “RI” is assigned with the code “6”. A button ID “RJ” is an ID that identifies a button displayed in the range 101j (illustrated in FIG. 1) on the security code entry screen (illustrated in FIG. 3) for right eye. The button ID “RJ” is assigned with the code “9”. The data entered by a number entry is identified on the basis of the codes

A button ID “RK” is an ID that identifies a button displayed in the range 101k (illustrated in FIG. 1) on the security code entry screen (illustrated in FIG. 3) for right eye. The button ID “RK” is assigned with “cancellation” of an instruction. A button ID “RL” is an ID that identifies a button displayed in the range 101l (illustrated in FIG. 1) on the security code entry screen (illustrated in FIG. 3) for right eye. The button ID “RL” is assigned with “execution” of an instruction.

Returning to FIG. 6, the display unit 603 causes the display 521 to display the security code entry screen (illustrated in FIG. 2) for left eye and the security code entry screen (illustrated in FIG. 3) for right eye. The acquirer 605 acquires events generated by operations performed using the touch pad 523 and the key group 525. The screen identifying unit 607 identifies a screen that is used as the standard screen. The code identifying unit 609 identifies a code on the basis of the screen that is used as the standard screen. The second storage unit 611 stores therein data such as a string of identified codes, for example. A part of the RAM 507 and the flash memory 509 is used for the second storage unit 611. The controller 613 controls the overall mobile phone terminal 500. The determining unit 615 determines the code string. In this example, the determining unit 615 determines a password. The password determination is one of examples of user authentication. The output unit 617 outputs the result of the determination. The result of the determination is displayed or transmitted, for example.

Next, a process is described. FIG. 9 illustrates an example of a flow of the process. The display unit 603 causes the display 521 to display the security code entry screen (illustrated in FIG. 2) for left eye and the security code entry screen (illustrated in FIG. 3) for right eye (S901). The acquirer 605 acquires a touch event generated by an operation of touching the touch pad 523 (S903). The event includes a button ID. The screen identifying unit 607 executes a process of identifying a screen that is used as the standard screen (S905). The first embodiment describes a process (A) of identifying a screen.

FIG. 10 illustrates a flow of the process (A) of identifying a screen. The screen identifying unit 607 reads data of the standard screen from the first storage unit 601 (S1001).

Returning to FIG. 9, the controller 613 determines whether the standard screen is the security code entry screen (indicated as “screen” in FIG. 9) for right eye or for left eye (S907).

If the controller 613 determines that the standard screen is the security code entry screen for right eye, the code identifying unit 609 identifies a code on the basis of the arrangement of the screen for right eye (S909). Specifically, the code identifying unit 609 identifies the code assigned to a button ID acquired from the touch event on the basis of the assignment table (illustrated in FIG. 8) for right eye.

If the controller 613 determines that the standard screen is the security code entry screen for left eye, the code identifying unit 609 identifies a code on the basis of the arrangement of the screen for left eye (S911). Specifically, the code identifying unit 609 identifies the code assigned to a button ID acquired from the touch event on the basis of the assignment table (illustrated in FIG. 7) for left eye.

The controller 613 determines whether code reception is completed (S913). For example, if a predetermined number of codes are received and the execution buttons is touched, the controller 613 determines that the code reception is completed. If the number of received codes is smaller than the predetermined number, the process returns to S903 and is repeated. If the cancellation buttons is touched, the process is interrupted and terminated, for example. In FIG. 9, the flow of a process up to the interruption and termination is omitted.

The determining unit 615 executes a code determination process (S915). Specifically, the determining unit 615 determines whether or not a string of received codes matches the password stored in the first storage unit 601. If the determining unit 615 determines that the string of the received codes matches the password stored in the first storage unit 601, “success” is set to the result of the determination. If the determining unit 615 determines that the string of the received codes does not match the password stored in the first storage unit 601, “failure” is set to the result of the determination.

The output unit 617 outputs the result of the determination (S917). For example, the output unit 617 causes the result to be displayed or transmits the result to another device. The result may not be output and may be used during the execution of an operating system or an application program installed in the mobile phone terminal 500.

According to the first embodiment, since it is unclear for the third person whether the screen for left eye or the screen for right eye is the standard screen, it may be possible to inhibit information of operations performed on the touch panel from being stolen.

Even if the third person peers at the touch panel in the direction of the line of sight of the left eye or in the direction of the line of sight of the right eye, it looks like the operator normally operates the display device. Thus, it is difficult for the third person to identify, from the appearance of the display device, whether the operator operates the display device on the basis of the line of sight of the left eye or the line of sight of the right eye.

Since the authentication is performed on the basis of a code string that is not easily stolen, the security is improved.

### Second Embodiment

The second embodiment describes an example in which the standard screen is specified on the basis of the order at which a numeric code is received.

The first storage unit 601 has stored therein a screen specifying table. FIG. 11 illustrates an example of the screen specifying table. The standard screen is specified in accordance with the order at which a numeric code is received. In this example, the security code entry screen for right eye is the standard screen when a code is received first. The security code entry screen for left eye is the standard screen when a code is received second. The security code entry screen for left eye is the standard screen when a code is received third. The security code entry screen for right eye is the standard screen when a code is received fourth.

The screen identifying unit 607 executes a process (B) of identifying a screen, instead of the process (A) illustrated in FIG. 10. FIG. 12 illustrates a flow of the process (B) of identifying a screen. The screen identifying unit 607 identifies the order at which a code is received (S1201). If the code is received first, the screen identifying unit 607 identifies that the code is the first received code. If the code is received second, the screen identifying unit 607 identifies that the code is the second received code. If the code is received third or fourth, the screen identifying unit 607 identifies that the code is the third or fourth received code, respectively.

The screen identifying unit 607 reads the standard screen corresponding to the order at which the code is received (S1203). Then, the process returns to S907 illustrated in FIG. 9.

According to the second embodiment, for each of received codes, either the screen for left eye or the screen for right eye is used as the standard screen may be switched. Thus, combinations of the screens for left eye and right eye exist for the number of the received codes and it is difficult for the third person to identify a code string.

### Third Embodiment

The third embodiment describes an example in which the arrangements of the numbers on the screens are changed by reassigning the numeric codes to the buttons for left eye and reassigning the numeric codes to the buttons for right eye.

FIG. 13 illustrates an example of a functional configuration of a mobile phone terminal 500 according to the third embodiment. The mobile phone terminal 500 according to the third embodiment has the configuration illustrated in FIG. 6 and a reassigning unit 1301. The reassigning unit 1301 changes the assignments included in the assignment table (illustrated in FIG. 7) for left eye and the assignments included in the assignment table (illustrated in FIG. 8) for right eye.

FIG. 14 illustrates a flow of an overall process according to the third embodiment. The reassigning unit 1301 changes the assignments included in the assignment table (illustrated in FIG. 7) for left eye and the assignments included in the assignment table (illustrated in FIG. 8) for right eye (S1401). The reassigning unit 1301 randomly reassigns the numeric codes to the button IDs “LA” to “U” in the assignment table (illustrated in FIG. 7) for left eye. The reassigning unit 1301 randomly reassigns the numeric codes to the button IDs “RA” to “RJ” in the assignment table (illustrated in FIG. 8) for right eye. The reassigning unit 1301 causes the numbers to be displayed on the buttons of the security code entry screen for left eye on the basis of the changed assignment table for left eye. In addition, the reassigning unit 1301 causes the numbers to be displayed on the buttons of the security code entry screen for right eye on the basis of the changed assignment table for right eye (S1403). S903 to S917 illustrated in FIG. 14 are the same as S903 to S917 illustrated in FIG. 9.

Although the example in which the assignments included in both assignment table for left eye and the assignment table for right eye are changed is described above, assignments included in only either the assignment table for left eye or the assignment table for right eye may be changed.

According to the third embodiment, since the arrangements of the numbers are changed, it is difficult to guess entered codes on the basis of the arrangements of the numbers.

### Fourth Embodiment

The fourth embodiment describes an example in which the standard screen is identified on the basis of a facial image including the eyes of the operator.

The screen identifying unit 607 executes a process (C) of identifying a screen, instead of the process (A) illustrated in FIG. 10 and the process (B) illustrated in FIG. 12. FIG. 15 illustrates a flow of the process (C) of identifying a screen. The screen identifying unit 607 reads the facial image acquired by the camera 529 (S1501).

The screen identifying unit 607 determines the states of respective eyes of the operator on the basis of the facial image (S1503). The screen identifying unit 607 determines whether or not the left eye is closed and the right eye is open (S1505). If the screen identifying unit 607 determines that the left eye is closed and the right eye is open, the screen identifying unit 607 determines that the standard screen is the security code entry screen for right eye (S1507). If the screen identifying unit 607 determines that the left eye is not closed or the right eye is not open, the screen identifying unit 607 determines whether or not the right eye is closed and the left eye is open (S1509). If the screen identifying unit 607 determines that the right eye is closed and the left eye is open, the screen identifying unit 607 determines that the standard screen is the security code entry screen for left eye (S1511). If the screen identifying unit 607 determines that the right eye is not closed or the left eye is not open, the screen identifying unit 607 executes a recovery process (S1513). In the recovery process, S1501 and later are repeated again, for example. In the recovery process, a code that indicates an error may be added to a code string instead of the repetition of S1501 and later, or the process may be interrupted and terminated.

The screen identifying unit 607 may determine the standard screen on the basis of one of the eyes. For example, the screen identifying unit 607 may determine the state of the left eye in order to determine the standard screen. If the left eye is closed, the screen identifying unit 607 may determine that the standard screen is the security code entry screen for right eye. If the left eye is open, the screen identifying unit 607 may determine that the standard screen is the security code entry screen for left eye. In addition, the screen identifying unit 607 may determine the state of the right eye in order to determine the standard screen. If the right eye is closed, the screen identifying unit 607 may determine that the standard screen is the security code entry screen for left eye. If the right eye is open, the screen identifying unit 607 may determine that the standard screen is the security code entry screen for right eye.

According to the fourth embodiment, since the screen identifying unit 607 automatically determines the state of an eye corresponding to the direction of the line of sight, the standard screen for the operator is not erroneously determined. In addition, since the operator arbitrarily selects a screen to be used as the standard screen by using respective eyes for the screens, it is difficult to guess a code string on the basis of a pattern of the switching of the standard screen.

### Fifth Embodiment

The fifth embodiment describes an example in which the standard screen is specified by an operation of the operator. Thus, a part of the key group 525 is assigned to a key for specifying the screen for right eye and a key for specifying the screen for left eye.

The screen identifying unit 607 executes a process (D) of identifying a screen, instead of the process (A) illustrated in FIG. 10, the process (B) illustrated in FIG. 12, and the process (C) illustrated in FIG. 15.

FIG. 16 illustrates a flow of the process (D) of identifying a screen. The screen identifying unit 607 acquires a key event (S1601). The screen identifying unit 607 determines whether the acquired key event has been generated by pressing of the key for specifying the screen for right eye or by pressing of the key for specifying the screen for left eye (S1603). If the acquired key event has been generated by pressing of the key for specifying the screen for right eye, the screen identifying unit 607 determines that the standard screen is the security code entry screen for right eye (S1605). If the acquired key event has been generated by pressing of the key for specifying the screen for left eye, the screen identifying unit 607 determines that the standard screen is the security code entry screen for left eye (S1607). Then, the process returns to S907 illustrated in FIG. 9 or S907 illustrated in FIG. 14.

An event other than key events may be used. If the display device has a dial or a lever, the standard screen may be specified by a dial operation or a lever operation. In addition, the standard screen may be specified on the basis of ON and OFF states of a key.

According to the fifth embodiment, since the operator arbitrarily specifies a screen that is used as the standard screen, it is difficult to guess a code string on the basis of a pattern of the switching of the standard screen. In addition, the operator does not have to remember a predetermined pattern of the switching of the standard screen.

### Sixth Embodiment

The sixth embodiment describes an example in which the frame sequential 3D display device is used to alternately display the security code entry screen for left eye and the security code entry screen for right eye, control the liquid crystal shutter glasses 551 so as to cause light for displaying a screen used as the standard screen to pass through the liquid crystal shutter glasses 551, and enable the operator to see the standard screen.

FIG. 17 illustrates a flow of an overall process according to the sixth embodiment. The frame sequential 3D display device displays the security code entry screen for left eye and the security code entry screen for right eye (S901).

The screen identifying unit 607 executes a process of identifying a screen (S1701). For example, the process (A) illustrated in FIG. 10, the process (B) illustrated in FIG. 12, or the process (D) illustrated in FIG. 16 is executed. The controller 613 controls the liquid crystal shutter glasses 551 through the liquid crystal shutter controller 527 so as to cause the liquid crystal shutter glasses 551 to shield light for a screen that is not used as the standard screen (S1703). While the operator sees the standard screen, the acquirer 605 acquires a touch event (S1705).

S907 to S917 illustrated in FIG. 17 are the same as S907 to S917 illustrated in FIG. 9.

According to the sixth embodiment, since the frame sequential 3D display device enables the operator to see a screen that is used as the standard screen, the operator does not have to intentionally use respective eyes.

In the embodiments, the numeric codes are used as an example of the codes, but the codes may be character codes or symbolic codes.

In the embodiments, the buttons are used as an example of the display elements, but the display elements may be replaced with a menu, icons, or the like.

The method for receiving entered data according to the embodiments is installed as a computing system having a touch panel device provided with the display device and software to be executed on the computing system. The computing system may be a mobile phone, a smart phone, a personal digital assistant (PDA), a small personal computer (PC), or the like. The computing system may be a device for financial institutions. In this case, the device for financial institutions is, for example, an automated teller machine.

Although the embodiments are described above, embodiments are not limited to the above-described embodiments. For example, the aforementioned functional block configurations may not match the actual program functional configurations.

The configurations of the aforementioned storage regions are examples, and the storage regions may have other configurations than the aforementioned configurations. In the process flows, the orders of the processes may be changed as long as the results of the processes are not changed. In the process flows, two or more of the processes may be executed in parallel.

The embodiments are summarized as follows.

A method for receiving entered data according to an aspect includes a process of displaying a screen for left eye and a screen for right eye in the same display region of a touch panel, a process of acquiring an event corresponding to an operation performed in the display region, a first process of identifying a screen used as a standard screen from among the screen for left eye and the screen for right eye, and a second process of identifying an instruction provided by the event.

According to the method, since it is unclear for a third person whether the standard screen is the screen for left eye or the screen for right eye, it may be possible to inhibit information of an operation performed on the touch panel from being stolen.

In the display process, a display element included in the screen for left eye and provided for left eye and a display element included in the screen for right eye and provided for right eye may be displayed in the same range within the display region. In the acquisition process, the event that corresponds to the operation performed in the range may be acquired. In the second identification process, if the standard screen is the screen for left eye, a first instruction that corresponds to the display element for left eye may be identified, and if the standard screen is the screen for right eye, a second instruction that corresponds to the display element for right eye may be identified.

In this case, even if the third person peers at the touch panel in the direction of the line of sight of the left eye of an operator and in the direction of the line of sight of the right eye of the operator, it looks like the operator normally operates a display device. Thus, it is difficult for the third person to identify, from the appearance of the display device, whether the operator operates the display device on the basis of the line of sight of the left eye or the line of sight of the right eye.

In the display process, information indicating the first instruction may be displayed in a first display element, and information indicating the second instruction may be displayed in a second display element.

In this case, the operator may identify the content of an instruction according to the line of sight of the left eye and the content of an instruction according to the line of sight of the right eye.

The instruction provided by the event may be an instruction to receive a code corresponding to a number, a character, or a symbol. In the first identification process, the screen that is used as the standard screen may be identified on the basis of the order at which the code is received.

In this case, for each of received codes, either the screen for left eye or the screen for right eye is used as the standard screen may be switched. Thus, combinations of the screens for left eye and right eye exist for the number of the received codes, and it is difficult for the third person to identify a code string.

The instruction provided by the event may be an instruction to receive any of a plurality of codes corresponding to predetermined numbers, characters, or symbols. In the display process, one of display elements that are included in the screen for left eye and provided for left eye and one of display elements that are included in the screen for right eye and provided for right eye may be displayed in each of the plurality of ranges within the display region. In the acquisition process, the event that corresponds to an operation performed in any of the multiple ranges may be acquired. In the second identification process, if the screen for left eye is the standard screen, an instruction to receive a code assigned to a display element provided for left eye and displayed in the range corresponding to the operation of the event may be identified in accordance with assignments of codes to display elements for left eye, and if the screen for right eye is the standard screen, an instruction to receive a code assigned to a display element provided for right eye and displayed in the range corresponding to the operation of the event may be identified in accordance with assignments of codes to display elements for right eye.

The method for receiving entered data may include a process of changing at least one of the assignments of the plurality of codes to the display elements for left eye and the assignments of the plurality of codes to the display elements for right eye.

In this case, at least one of the arrangements of the codes is changed, and it is, therefore, difficult to guess received codes on the basis of the arrangements of the codes.

In the first identification process, the screen that is used as the standard screen may be identified on the basis of an image of both or one of eyes of the operator.

In this case, the state of an eye that corresponds to the direction of the line of sight is automatically determined, and the screen that is used as the standard screen for the operator is not erroneously identified. In addition, since the operator arbitrarily selects a screen to be used as the standard screen by using the respective eyes for the screens, it is difficult to guess a code string on the basis of a pattern of the switching of the standard screen.

The method for receiving entered data may include a process of receiving an operational event corresponding to specifying of the screen that is used as the standard screen.

In the first identification process, the screen that is used as the standard screen may be identified in accordance with the specifying.

In this case, the operator may arbitrarily identify the screen that is used as the standard screen, and it is, therefore, difficult to guess a code string on the basis of a pattern of the switching of the standard screen. In addition, the operator does not have to remember a predetermined pattern of the switching of the standard screen.

In the display process, liquid crystal shutter glasses may be controlled so as to cause light for displaying the screen used as the standard screen, which is either the screen for left eye or the screen for right eye, to pass through the liquid crystal shutter glasses.

In this case, the operator may see the screen used as the standard screen and does not have to intentionally use the respective eyes.

The method for receiving entered data may include a process of executing authentication on the basis of a code string of codes received in accordance with the instructions provided by the events.

In this case, the authentication is executed on the basis of the code string that is not easily stolen, and the security is improved.

A program that causes the processor to execute the aforementioned processes may be created and stored in a computer-readable recording medium or a storage device. The computer-readable recording medium or the storage device may be a flexible disk, a compact disc read-only memory (CD-ROM), a magneto-optical disc, a semiconductor memory, a hard disk, or the like. Results that are obtained during the processes are temporarily stored in a storage device such as a main memory in general.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method for receiving entered data, the method comprising:
displaying, by a computer, a first screen for left eye and a second screen for right eye in a same display region of a display device;
acquiring an event corresponding to an operation performed on a screen displayed in the display region;
identifying a screen used as a standard screen from among the first screen and the second screen; and
identifying an instruction provided by the event on basis of the screen used as the standard screen.

2. The method according to claim 1, wherein
the computer displays a first display element provided for left eye and included in the first screen and a second display element provided for right eye and included in the second screen in a same range within the display region,
the operation is performed in the range,
the computer identifies a first instruction corresponding to the first display element if the first screen is used as the standard screen, and
the computer identifies a second instruction corresponding to the second display element if the second screen is used as the standard screen.

3. The method according to claim 2, wherein
the computer displays information indicating the first instruction in the first display element, and
the computer displays information indicating the second instruction in the second display element.

4. The method according to claim 1, wherein
the instruction provided by the event is an instruction to receive a code corresponding to a number, a character, or a symbol, and
the computer identifies the screen used as the standard screen on basis of an order at which the code is received.

5. The method according to claim 1, wherein
the instruction provided by the event is an instruction to receive any of a plurality of codes corresponding to predetermined numbers, characters, or symbols,
the computer displays one of first display elements provided for left eye and included in the first screen and one of second display elements provided for right eye and included in the second screen in each of a plurality of ranges within the display region,
the operation is performed in any of the plurality of ranges,
the computer identifies, if the first screen is used as the standard screen, an instruction to receive a code assigned to a display element provided for left eye and displayed in a range corresponding to the operation of the event in accordance with first assignments of the plurality of codes to the first display elements,
the computer identifies, if the second screen is used as the standard screen, an instruction to receive a code assigned to a display element provided for right eye and displayed in a range corresponding to the operation of the event in accordance with second assignments of the plurality of codes to the second display elements, and
the computer further changes at least one of the first assignments and the second assignments.

6. The method according to claim 1, wherein
the computer identifies the screen used as the standard screen on basis of an image of both or one of eyes of an operator.

7. The method according to claim 1, wherein
the computer further receives an operational event corresponding to specifying of the screen used as the standard screen, and
the computer identifies the screen used as the standard screen in accordance with the specifying.

8. The method according to claim 1, wherein
the computer controls liquid crystal shutter glasses so as to cause light for displaying the screen used as the standard screen to pass through the liquid crystal shutter glasses.

9. The method according to claim 4, wherein
the computer further executes authentication on basis of a code string of codes each received in accordance with the instruction provided by the event.

10. A computer-readable recording medium having stored therein a program for causing a computer to execute a process, the process comprising:
displaying a first screen for left eye and a second screen for right eye in a same display region of a display device;
acquiring an event corresponding to an operation performed on a screen displayed in the display region;
identifying a screen used as a standard screen from among the first screen and the second screen; and
identifying an instruction provided by the event on basis of the screen used as the standard screen.

11. An information processing device, comprising:
a processor to
display a first screen for left eye and a second screen for right eye in a same display region of a display device,
acquire an event corresponding to an operation performed on a screen displayed in the display region,
identify a screen used as a standard screen from among the first screen and the second screen, and
identify an instruction provided by the event on basis of the screen used as the standard screen.
